(19) United States
(12) Patent Application Publication
(10) Pub. No.: US 2018/0304321 A1
(43) Pub. Date: Oct. 25, 2018

(54) ANTI-FOULING SYSTEM, CONTROLLER AND METHOD OF CONTROLLING THE ANTI-FOULING SYSTEM

(71) Applicant: KONINKLIJKE PHILIPS N.V., EINDHOVEN (NL)

(72) Inventors: Cornelis Gerardus VISSER, Eindhoven (NL); Roelant Boudewijn HIETBRINK, Utrecht (NL); Bart Andre SALTERS, Eindhoven (NL)

(73) Assignee: KONINKLIJKE PHILIPS N.V.

(21) Appl. No.: 15/769,940

(22) PCT Filed: Oct. 11, 2016
(86) PCT No.: PCT/EP2016/074333

§ 371 Date: Apr. 20, 2018

(30) Foreign Application Priority Data
Oct. 27, 2015 (EP) 15191712.7

(51) Int. Cl. B08B 17/02; B08B 9/08; B08B 7/00; B63J 4/00; F28D 1/02; F28D 7/06; F28F 19/00

(52) U.S. Cl. CPC B08B 17/02; B08B 9/08; B08B 7/0057; B08B 7/0064; B08B 9/023; F28D 1/022; F28D 7/06; F28F 19/00; B63J 4/002

(57) ABSTRACT

An anti-fouling system (1) for use with a wet compartment (10) having at least one inlet opening (11) for allowing water to enter the compartment (10) is configured to receive and operate at least one anti-fouling source for emitting anti-fouling light in order to keep at least one surface (26) as present in the compartment (10) free from biofouling. The system (1) comprises a controller (50) for controlling operation of the at least one anti-fouling source (30), the controller (50) being configured to determine at least one operation parameter of the at least one anti-fouling source (30) in relation to at least one of at least one water-related parameter, at least one surface-related parameter and at least one opening-related parameter.

### FIELD OF THE INVENTION

The invention relates to an anti-fouling system, designed to be used with a wet compartment having at least one inlet opening for allowing water to enter the wet compartment, the anti-fouling system being configured to receive and operate at least one anti-fouling source for emitting anti-fouling light in order to keep at least one surface as present in the wet compartment free from biofouling, and the anti-fouling system comprising a controller for controlling operation of the at least one anti-fouling source when the anti-fouling source is received in the anti-fouling system and the anti-fouling system is used with the wet compartment. Secondly, the invention relates to a vessel comprising a wet compartment having at least one inlet opening for allowing water to enter the wet compartment, and the anti-fouling system as mentioned.

Thirdly, the invention relates to a method for controlling operation of at least one anti-fouling source of an anti-fouling system when the anti-fouling system is used with a wet compartment having at least one inlet opening for allowing water to enter the wet compartment, the at least one anti-fouling source being configured to emit anti-fouling light in order to keep at least one surface as present in the wet compartment free from biofouling.

Fourthly, the invention relates to a controller for controlling operation of at least one anti-fouling source of an anti-fouling system when the anti-fouling system is used with a wet compartment having at least one inlet opening for allowing water to enter the wet compartment, the at least one anti-fouling source being configured to emit anti-fouling light in order to keep at least one surface as present in the wet compartment free from biofouling. Fifthly, the invention relates to an anti-fouling system, designed to be used with a wet compartment having at least one inlet opening for allowing water to enter the wet compartment, which system comprises a controller as mentioned and which system is suitable to receive at least one anti-fouling source for emitting anti-fouling light in order to keep at least one surface as present in the wet compartment free from biofouling.

### BACKGROUND OF THE INVENTION

In vessels such as ships, wet compartments may be present for various purposes. For example, a ship may be equipped with a so-called sea chest for taking in seawater, the sea chest being defined by a portion of the hull of the ship and partition plates, and the sea chest having at least one inlet opening for allowing seawater to enter the sea chest. The presence of such a sea chest allows for use of seawater as ballast water or fire extinguishing water in the ship, to mention only two of the various possibilities.

Normally, a ship is equipped with various kinds of machinery, and it is also possible that one or more sea chests are used for accommodating at least a portion of a heat exchanger which is part of a machinery cooling system. In such a case, the heat exchanger may be a so-called box cooler, which is a cooling apparatus comprising a plurality of tubes for containing and transporting fluid to be cooled in their interior, wherein it is a practical option for the sea chest to be adapted to accommodate the tubes of the box cooler, and to have both inlet openings and outlet openings so that water can enter the sea chest, flow over the tubes in the sea chest, and exit the sea chest through natural flow and/or under the influence of motion of the ship.

A box cooler is a specific type of heat exchanger which is designed for use in an engine-driven ship. For example, in the case of a tugboat having an installed engine power of 15 MW, one or more box coolers are applied for transferring heat in the order of 5 MW to the seawater. Usually, a box cooler comprises bundles of U-shaped tubes for conducting a fluid to be cooled, wherein ends of leg portions of the tubes are secured to a common plate having openings for providing access to both leg portions of each of the tubes. It is a very practical option to enable the box cooler to perform its cooling function by continuously exposing the tubes thereof to fresh seawater. However, the environment of a box cooler is ideally suited for a phenomenon known as biological fouling or biofouling, as the seawater is heated to a medium temperature in the vicinity of the tubes as a result of the heat exchange with the relatively hot fluid in the interior of the tubes, and the constant flow of water continuously brings in new nutrients and organisms which are known to cause biofouling.

In general, biofouling is the accumulation of microorganisms, plants, algae, small animals and the like on surfaces. According to some estimates, over 1,800 species comprising over 4,000 organisms are responsible for biofouling. Hence, biofouling is caused by a wide variety of organisms, and involves much more than an attachment of barnacles and seaweeds to surfaces. Biofouling is divided into micro fouling which includes biofilm formation and bacterial adhesion, and macro fouling which includes the attachment of larger organisms. Due to the distinct chemistry and biology that determine what prevents them from settling, organisms are also classified as being hard or soft. Hard fouling organisms include calcareous organisms such as barnacles, encrusting bryozoans, mollusks, polychaetes and other tube worms, and zebra mussels. Soft fouling organisms include non-calcareous organisms such as seaweed, hydroids, algae and biofilm “slime”. Together, these organisms form a fouling community.

In several situations, biofouling creates substantial problems. Biofouling can cause machinery to stop working, water inlets to get clogged, and heat exchangers to suffer from reduced performance. Hence, the topic of anti-fouling, i.e. the process of removing or preventing biofouling, is well-known. In industrial processes involving wetted surfaces, bio dispersants can be used to control biofouling. In less controlled environments, fouling organisms are killed or repelled with coatings using biocides, thermal treatments or pulses of energy. Nontoxic mechanical strategies that prevent organisms from attaching to a surface include choosing a material or coating for causing the surface to be slippery, or creating nanoscale surface topologies similar to the skin of sharks and dolphins which only offer poor anchor points.

Biofouling of box coolers causes severe problems. The main issue is a reduced heat transferring capability as layers of biofouling are effective heat insulators. When the biofouling layers are so thick that seawater can no longer circulate between adjacent tubes of the box cooler, an additional deteriorating effect on the heat transfer is obtained. Thus, biofouling of box coolers increases the risk of engine over-heating, so that ships need to slow down or ship engines get damaged.

Anti-fouling arrangements for cooling units that cool the water from a cooling water system of an engine-driven ship by means of seawater are known in the art. For example, DE 102008029464 relates to a box cooler for use in ships and on offshore platforms, comprising an integrated anti-fouling system for killing fouling organisms by means of an overheating process that can be regularly repeated. In particular, the box cooler is protected against microorganism fouling by continuously overheating a defined number of heat exchanger tubes without interrupting the cooling process, wherein waste heat from the cooling water may be used for doing so.

In general, it is known in the art to use ultraviolet light for removing/preventing the formation of biofilm on wet surfaces. For example, WO 2014/014779 discloses a system for reducing fouling of a surface of an optically transparent element subjected to a marine environment, including a LED for emitting ultraviolet radiation, a mount for directing emitted ultraviolet radiation toward the optically transparent element, and control circuitry for driving the LED.

The invention relates to the use of an anti-fouling system in a wet compartment, the anti-fouling system being configured to receive and operate at least one anti-fouling source which is adapted to emit anti-fouling light for achieving that at least one surface as present in the wet compartment is kept free from biofouling. In a practical application of the invention, the at least one anti-fouling source may comprise at least one ultraviolet lamp, and the at least one surface to be kept free from biofouling may comprise an interior surface of an actual structure of the wet compartment and/or an exterior surface of a functional unit as may be present in the wet compartment and/or any other any possible other surface which is to be kept clean. A functional unit may be the plurality of tubes of a box cooler as mentioned in the foregoing, which does not alter the fact that numerous other types of functional units are possible within the framework of the invention as well.

For minimizing maintenance and inspection costs of the anti-fouling system, it is desirable to maximize the lifetime of the at least one anti-fouling source for use in the system. On the other hand, this should not involve a reduction of the anti-fouling source's ability to effectively perform its anti-fouling function on the one or more wet surfaces to which it is assigned. It is an object of the invention to provide an appropriate way of controlling operation of at least one anti-fouling source of an anti-fouling system, by means of which it is possible to meet the various requirements in an improved manner.

### SUMMARY OF THE INVENTION

According to the invention, an anti-fouling system, designed to be used with a wet compartment having at least one inlet opening for allowing water to enter the wet compartment is provided, the anti-fouling system being configured to receive and operate at least one anti-fouling source for emitting anti-fouling light in order to keep at least one surface as present in the wet compartment free from biofouling, and the anti-fouling system comprising a controller for controlling operation of the at least one anti-fouling source when the anti-fouling source is received in the anti-fouling system and the anti-fouling system is used with the wet compartment, the controller being configured to determine at least one operation parameter of the at least one anti-fouling source in relation to at least one of at least one water-related parameter, at least one surface-related parameter and at least one opening-related parameter.

In the anti-fouling system according to the invention, the controller serves for controlling operation of the at least one anti-fouling source when the anti-fouling source is received in the anti-fouling system and the anti-fouling system is used with the wet compartment, and the controller is configured to determine at least one parameter of the operation of the at least one anti-fouling source in relation to aspects of an actual situation prevailing in the wet compartment by taking into account at least one of at least one water-related parameter, at least one surface-related parameter and at least one opening-related parameter. This allows for optimal adaptation of the operation of the anti-fouling source to the actual situation. For example, the anti-fouling source may be powered to such an extent that a minimum of energy is used for obtaining the anti-fouling effect as desired under all circumstances. It is possible to do so on the basis of existing relations between various conditional aspects and an extent of biofouling. For example, when water is present inside the wet compartment, and the temperature of the water is about 30° C., the anti-fouling source needs to be operated to emit more energy than in a case in which the temperature of the water is about 10° C. In known systems, i.e. systems without the operation control options of the invention, the anti-fouling source is powered to the relatively high extent under all circumstances, in order to prevent biofouling under all circumstances. Contrariwise, according to the invention, the anti-fouling source is powered at a lower extent as soon as this appears to be possible without deteriorating the anti-fouling effect to be achieved, whereby energy is saved and the lifetime of the anti-fouling source is prolonged.

In particular, according to the invention, the controller of the anti-fouling system may be configured to determine the at least one parameter of the operation of the at least one anti-fouling source in relation to at least one of the following water-related parameters:

a rate of a flow of water along the surface to be kept free from biofouling;
a temperature of water inside the wet compartment;
an extent to which water inside the wet compartment is transparent to the anti-fouling light;
an algal content of water inside the wet compartment;
a concentration of copper ions in water inside the wet compartment; and
a concentration of chlorine in water inside the wet compartment.

In respect of the first water-related parameter, i.e. the rate of a flow of water along the surface to be kept free from biofouling, it is noted that this parameter is suitable to be used for determining whether the anti-fouling source needs to be operated or can be switched off or nearly off, i.e. can be operated to a minimal extent only. The fact is that at relatively high flow rates such as flow rates above 3 m/s, the shear stress of the water with respect to the surface exceeds the shear strength of the biofouling organisms. Thus, it is possible to determine a suitable threshold value in respect of the flow rate, and to control the operation of the anti-fouling source in such a way that the anti-fouling source is switched (nearly) off during periods of high flow rate.

In respect of the second water-related parameter, i.e. the temperature of water inside the wet compartment, it is noted that this parameter is suitable to be used for determining whether the anti-fouling source needs to be operated or can be switched (nearly) off. The fact is that at relatively high temperatures such as temperatures above 75° C., biofouling mortality is realized. Thus, it is possible to determine a suitable threshold value in respect of the water temperature, and to control the operation of the anti-fouling source in such a way that the anti-fouling source is switched (nearly) off during periods of high water temperature.

In respect of the third water-related parameter, i.e. the extent to which water inside the wet compartment is transparent to anti-fouling light emitted by the at least one anti-fouling source, it is noted that this parameter is suitable to be used for determining whether the anti-fouling source needs to be operated at a default power level or can be operated at a lower power level. The fact is that in water which is highly transparent to the energy, less power is needed for achieving the same anti-fouling effect as in water that is less transparent. Thus, it is possible to determine a suitable threshold value in respect of the water transparency, and to control the operation of the anti-fouling source in such a way that the anti-fouling source is operated at a reduced power level when highly transparent water is present inside the wet compartment.

In respect of the fourth water-related parameter, i.e. the algal content of water inside the wet compartment, it is noted that this parameter is suitable to be used for determining whether the anti-fouling source needs to be operated at a default power level or can be operated at a lower power level or even be switched off, especially in cases in which biofouling is caused by algal blooms. The fact is that if the algal concentrations exceed a certain threshold, the amount of algae is large enough to release organisms triggering biofouling. Another similar indicator of the biofouling potential of the water is the content of algae measured as chlorophyll-a. Water with a high amount can be expected to have very high biofouling propensity. Thus, it is possible to determine a suitable threshold value in respect of the algal content, and to control the operation of the anti-fouling source in such a way that the anti-fouling source is operated at a reduced power level or switched off when the actual value of the algal content is below the threshold value.

In respect of the fifth water-related parameter, i.e. the concentration of copper ions in water inside the wet compartment, it is noted that this parameter is suitable to be used in a situation in which the anti-fouling system according to the invention furthermore comprises a so-called ICAF system. ICAF (Impressed Current Anti Fouling) systems are adapted to electrolytically produce copper ions, and are well-known in the field of biofouling prevention. The electrolytic system comprises a pair of anodes, wherein the anodes are made of copper in most cases. During operation of the system, DC current is passed through the anodes, so that ions are produced which are suitable for preventing marine organisms from settling down and multiplying on the surface to be kept free from biofouling. The lifetime of the at least one anti-fouling source of the anti-fouling system according to the invention can be increased by keeping the anti-fouling source in an inactive state as long as the concentration of copper ions is high enough for total prevention of biofouling. On the other hand, the lifetime of the ICAF system can be prolonged as well, compared to a situation in which no other anti-fouling measures are taken than the application of the ICAF system, while maintenance can take place at longer intervals. In case the anti-fouling source comprises a source for emitting ultraviolet light during operation thereof, the ICAF system may particularly be activated in cases of low transparency of the water to the ultraviolet light. In view thereof, the controller may be configured to operate the ICAF system and to switch off the anti-fouling source in case the transparency gets lower than a certain threshold, and to switch off the ICAF system and to operate the anti-fouling source in case the transparency exceeds the threshold and the concentration of copper ions is no longer sufficient for guaranteeing a sufficient anti-fouling action.

In respect of the sixth water-related parameter, i.e. the concentration of chlorine in water inside the wet compartment, it is noted that this parameter is suitable to be used in a situation in which the anti-fouling system according to the invention furthermore comprises an electro-chlorination system for generating chlorine for the purpose of producing sodium hypochlorite which is known to be effective in preventing biofouling. Electro-chlorination systems are suitable to be used in seawater only, and comprise a cathode made of titanium and an anode made of titanium covered with a thin layer of platinum. During operation of an electro-chlorination system, the layer at the anode is consumed. The lifetime of the at least one anti-fouling source of the anti-fouling system according to the invention can be increased by keeping the anti-fouling source in an inactive state as long as the concentration of chlorine is high enough for total prevention of biofouling. On the other hand, the lifetime of the electro-chlorination system can be prolonged as well, compared to a situation in which no other anti-fouling measures are taken than the application of the electro-chlorination system, while maintenance can take place at longer intervals and the need for renewing the anode occurs less frequently.

According to the invention, in addition to or instead of at least one water-related parameter, at least one surface-related parameter can be used for the purpose of determining at least one parameter of operation of the at least one anti-fouling source. For the sake of clarity, it is noted that a surface-related parameter is a parameter related to the surface to be kept free from biofouling. One example of a surface-related parameter is a temperature of the surface. This parameter is particularly suitable to be used for determining whether the anti-fouling source needs to be operated or can be switched (nearly) off The fact is that at relatively high surface temperatures such as temperatures above 75° C., the effect of fouling appears to be little. Thus, it is possible to determine a suitable threshold value in respect of the surface temperature, and to control the operation of the anti-fouling source in such a way that the anti-fouling source is switched (nearly) off during periods of high surface temperature.

In a situation in which the water in the wet compartment is stationary, i.e. in which the wet compartment is filled with a certain volume of water during a certain period of time, control of the anti-fouling source can be aimed at initially providing a dose of energy so as to sterilize the water, and subsequently switching off the anti-fouling source or only operating the anti-fouling source to a minimal extent, and keeping the anti-fouling source in a state of minimal/zero operation as long as there is no fresh supply of water. It is possible to use the rate of a flow of water along the surface to be kept free from biofouling in a process of determining whether water in the wet compartment is stationary, or not, but it is also possible to use another water-related parameter such as a rate of a flow of water through the at least one inlet opening of the wet compartment. In either case, the sterilization action followed by switching (nearly) off the anti-fouling system can be initiated as soon as the flow rate appears to be practically zero during a predetermined amount of time. Alternatively, in a case that the inlet opening can actually be put in a closed state, an action of switching from an opened state of the inlet opening to the closed state may trigger initiation of the sterilization action followed by switching (nearly) off the anti-fouling source. Hence, in such a case, an opening-related parameter is used for determining at least one parameter of operation of the anti-fouling source. In a general sense, when the at least one inlet opening of the wet compartment is adapted to be in one of an opened state and a closed state, the controller may be configured to determine the at least one operation parameter in relation to the state of the inlet opening, and may particularly be configured to control the at least one anti-fouling source for providing a dose of anti-fouling light followed by switching (nearly) off the anti-fouling source when the opening is put from the opened state to the closed state, and to keep the anti-fouling source in a state of minimal/zero activity, at least during a predetermined period of time as long as the closed state is maintained.

In a practical embodiment, the anti-fouling system according to the invention comprises at least one sensor for detecting an actual value of the at least one of the at least one water-related parameter, the at least one surface-related parameter and the at least one opening-related parameter, the sensor being associated with the controller so as to be capable of providing feedback about the value to the controller. For example, the anti-fouling system may be equipped with at least one of a flow sensor, a temperature sensor etc.

The controller may especially be configured to determine an intensity of energy to be emitted by the at least one anti-fouling source through time in relation to the at least one of the at least one water-related parameter, the at least one surface-related parameter and the at least one opening-related parameter. The intensity can be varied from zero to a maximum value, depending on the actual value of the at least one of the at least one water-related parameter, the at least one surface-related parameter and the at least one opening-related parameter, so as to have a minimum load of the anti-fouling source in each situation without increasing the risk of biofouling.

Within the framework of the invention, it is a practical possibility to make use of a fouling control model configured to determine output related to the at least one operation parameter of the at least one anti-fouling source in relation to input related to the at least one of the at least one water-related parameter, the at least one surface-related parameter and the at least one opening-related parameter. Such a fouling control model may be provided in the form of a look-up table, for example, or a set of equations. Advantageously, the controller comprises a memory in which the fouling control model is stored.

The at least one anti-fouling source for use in the anti-fouling system according to the invention may be adapted to emit ultraviolet light. The anti-fouling source may be suitable for arrangement inside the wet compartment or outside of the wet compartment, whatever positioning of the anti-fouling source is appropriate. In the latter case, measures may be taken to allow for transfer of energy emitted by the anti-fouling source during operation thereof from the outside to the inside of the wet compartment. In case an ultraviolet light source is applied, the controller may be used for switching the light source on and off at appropriate moments, determining an appropriate duty cycle of operation of the light source, etc., in dependency of the at least one of the at least one water-related parameter, the at least one surface-related parameter and the at least one opening-related parameter.

For the sake of completeness, the following is noted in respect of anti-fouling by using ultraviolet light. The anti-fouling light source may be chosen to specifically emit ultraviolet light of the c type, which is also known as UVC light, and even more specifically, light with a wavelength roughly between 250 nm and 300 nm. It has been found that most fouling organisms are killed, rendered inactive, or rendered unable to reproduce by exposing them to a certain dose of the ultraviolet light. A typical intensity which appears to be suitable for realizing anti-fouling is 10 mW per square meter, to be applied continuously or at a suitable frequency. A very efficient source for producing UVC light is a low pressure mercury discharge lamp, in which an average of 35% of input power is converted to UVC power. Another useful type of lamp is a medium pressure mercury discharge lamp. The lamp may be equipped with an envelope of special glass for filtering out ozone-forming radiation. Furthermore, a dimmer may be used with the lamp if so desired. Other types of useful UVC lamps are dielectric barrier discharge lamps, which are known for providing very powerful ultraviolet light at various wavelengths and at high electrical-to-optical power efficiencies, and LEDs. In respect of the LEDs, it is noted that they can generally be included in relatively small packages and consume less power than other types of light sources. LEDs can be manufactured to emit (ultraviolet) light of various desired wavelengths, and their operating parameters, most notably the output power, can be controlled to a high degree.

The light source for emitting ultraviolet light can be provided in the form of a tubular lamp, more or less comparable to a well-known TL (tube luminescent/fluorescent) lamp. For various known germicidal tubular UVC lamps, the electrical and mechanical properties are comparable to those properties of tubular lamps for producing visible light. This allows the UVC lamps to be operated in the same way as the well-known lamps, wherein an electronic or magnetic ballast/starter circuit may be used, for example.

A general advantage of using ultraviolet light for realizing anti-fouling is that the microorganisms are prevented from adhering and rooting on the surface to be kept clean. Contrariwise, when known poison dispersing coatings are applied, the anti-fouling effect is achieved by killing the microorganisms after they have adhered and rooted on the surface. Prevention of biofouling by means of light treatment is preferred over removal of biofouling by means of light treatment, as the latter requires more input power and involves a higher risk that the light treatment is not sufficiently effective.

The surface to be kept free from biofouling may include an interior surface of an actual structure of the wet compartment. In the case of a functional unit being arranged in the wet compartment, the surface in the wet compartment to be kept free from biofouling may include an exterior surface of that functional unit. The functional unit may be constituted by the plurality of tubes of a box cooler, as explained earlier, which does not alter the fact that many other possibilities exist.

One feasible application of the anti-fouling system according to the invention is in a vessel comprising a wet compartment having at least one inlet opening for allowing water to enter the wet compartment. Usually, a vessel comprises machinery, and it may be so that a functional unit of the machinery is arranged in the wet compartment. For example, the vessel may be equipped with a machinery cooling system including a cooling apparatus, a functional unit of the cooling apparatus being arranged in a wet compartment of the vessel, in which case the anti-fouling system may be used for preventing biofouling of at least one, preferably both of an interior surface of the actual structure of the wet compartment and an exterior surface of the functional unit of the cooling apparatus. The cooling apparatus may be a box cooler as mentioned earlier, and the functional unit may be constituted by the plurality of tubes of the box cooler, which serve for containing and transporting fluid to be cooled in their interior, and which are intended to be at least partially exposed to water during operation of the cooling apparatus. In such a case, as is known from the field of box coolers, at least a part of the cooling apparatus may have a layered structure in which the tubes are arranged in tube layers, each tube layer including at least one tube. In particular, the tube layers may include a number of U-shaped tubes having a curved bottom portion and two substantially straight leg portions, wherein the tubes of a tube layer have mutually different sizes, ranging from a smallest tube to a largest tube, the smallest tube having a smallest radius of the bottom portion, and the largest tube having a largest radius of the bottom portion, wherein top sides of the leg portions of the tubes are at a similar level in the cooling apparatus, and wherein the leg portions of the tubes extend substantially parallel to each other.

The invention furthermore relates to a method for controlling operation of at least one anti-fouling source of an anti-fouling system when the anti-fouling system is used with a wet compartment having at least one inlet opening for allowing water to enter the wet compartment, the at least one anti-fouling source being configured to emit anti-fouling light in order to keep at least one surface as present in the wet compartment free from biofouling, and the method involving a step of determining at least one parameter of the operation of the at least one anti-fouling source in relation to at least one of at least one water-related parameter, at least one surface-related parameter and at least one opening-related parameter. As explained in the foregoing, the invention thus provides a way of adapting the operation of the at least one anti-fouling source to actual circumstances prevailing in the wet compartment in an optimal manner, so that energy may be saved and the lifetime of the anti-fouling source may be prolonged, to mention two important advantages.

As explained earlier, in case the at least one inlet opening of the wet compartment is adapted to be in one of an opened state and a closed state, it is advantageous for the at least one anti-fouling source to be controlled for providing a dose of anti-fouling light followed by switching (nearly) off the anti-fouling source when the opening is put from the opened state to the closed state, and to keep the anti-fouling source in a state of no or minimal activity, at least during a predetermined period of time as long as the closed state is maintained.

Furthermore, as explained earlier, it may be practical for the method according to the invention to involve a step of detecting an actual value of the at least one of the at least one water-related parameter, the at least one surface-related parameter and the opening-related parameter. Also, it is possible for the method to involve a step of applying a fouling control model for determining output related to the at least one operation parameter in relation to input related to the at least one of the at least one water-related parameter, the at least one surface-related parameter and the at least one opening-related parameter. Needless to say that such a fouling control model is preferably based on the assumption that anti-fouling effects should be obtained to a sufficient extent yet at a minimum load of the anti-fouling source.

In another aspect, the invention relates to a controller for controlling operation of at least one anti-fouling source of an anti-fouling system, designed to be used with a wet compartment having at least one inlet opening for allowing water to enter the wet compartment, the at least one anti-fouling source being configured to emit anti-fouling light in order to keep at least one surface as present in the wet compartment free from biofouling.

In conformity with the above explanation, the controller according to the invention is characterized in that the controller is configured to determine at least one operation parameter of the at least one anti-fouling source in relation to at least one of at least one water-related parameter, at least one surface-related parameter and at least one opening-related parameter. Furthermore, it follows from the above explanation that the controller may be configured to control operation of at least one anti-fouling source which is adapted to emit anti-fouling light during operation thereof, and which is intended for use with a wet compartment of which the at least one inlet opening is adapted to be in one of an opened state and a closed state, in which case the controller is configured to control the anti-fouling source for providing a dose of anti-fouling light followed by switching (nearly) off the anti-fouling source in a situation of the opening being put from the opened state to the closed state, and to keep the anti-fouling source in a state of no or minimal activity in a situation of the closed state being maintained, at least during a predetermined period of time. Additionally or alternatively, the controller may be configured to control operation of at least one anti-fouling source which is adapted to emit anti-fouling light during operation thereof, and being configured to determine an intensity of anti-fouling light to be emitted by the at least one anti-fouling source through time in relation to the at least one of the at least one water-related parameter, the at least one surface-related parameter and the at least one opening-related parameter. In any case, the controller may comprise a memory in which a fouling control model configured to determine output related to the at least one operation parameter in relation to input related to the at least one of the at least one water-related parameter, the at least one surface-related parameter and the at least one opening-related parameter is stored.

The above-described and other aspects of the invention will be apparent from and elucidated with reference to the following detailed description of an anti-fouling system as used with a wet compartment, particularly an anti-fouling system which is configured to receive and operate an ultraviolet lamp, wherein especially a way in which the operation of the lamp is controlled will be explained.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a wet compartment, a functional unit arranged in the wet compartment, lamps for casting anti-fouling light over the exterior surface of the functional unit, an ICAF system arranged in the wet compartment, a controller for controlling operation of the lamps and the ICAF system, and a number of sensors coupled to the controller; and

FIG. 2 is a block diagram for illustrating possibilities in respect of control of operation of the lamps.

### DETAILED DESCRIPTION OF EMBODIMENTS

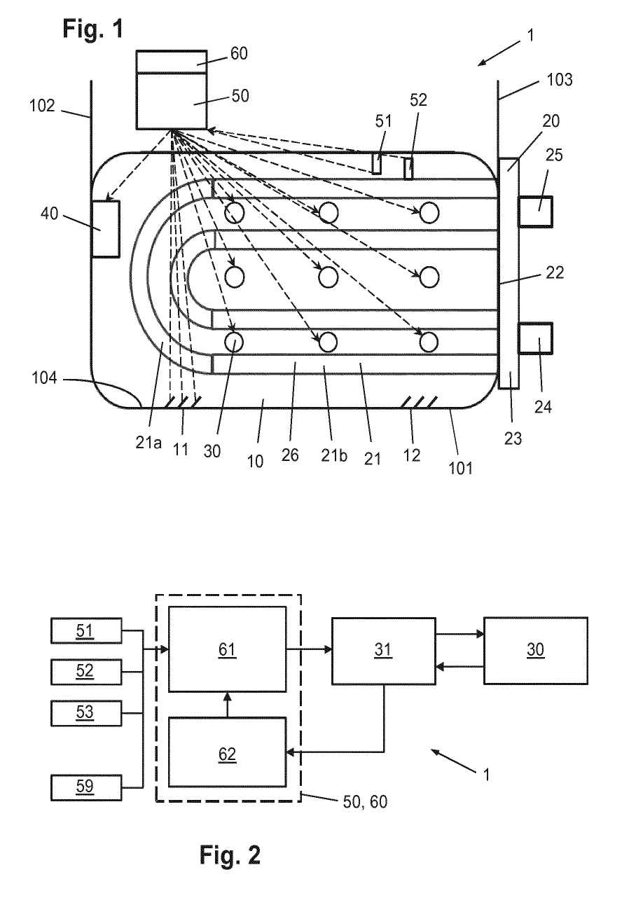

FIG. 1 diagrammatically shows a wet compartment 10 as present in a ship, and furthermore shows a box cooler 20 comprising a plurality of tubes 21 for containing and transporting a fluid to be cooled in their interior. The wet compartment 10 has a number of inlet openings 11 for allowing water to enter in and a number of outlet openings 12 for allowing water to flow out. The box cooler 20 is enabled to perform its function of cooling fluid by exposing the tubes 21 of the box cooler 20 to water from the immediate outside environment of the ship, which will hereinafter be referred to as seawater. In particular, the tubes 21 of the box cooler 20 are accommodated inside the wet compartment 10, the wet compartment 10 being delimited by a portion of the ship's hull 101 and partition plates 102, 103. Both the inlet openings 11 and the outlet openings 12 of the wet compartment 10 are arranged in the ship's hull 101, wherein the inlet openings 11 serve for allowing seawater to enter the wet compartment 10 from the outside, and wherein the outlet openings 12 serve for allowing seawater to exit the wet compartment 10 and to flow to the outside of the ship.

In the shown example, the tubes 21 of the box cooler 20 have a curved shape, particularly a U shape, comprising a curved bottom portion 21a and two substantially straight leg portions 21b extending substantially parallel to each other. During operation of the box cooler 20, fluid to be cooled, i.e. hot fluid, flows through the tubes 21, while seawater enters the wet compartment 10 through the inlet openings 11. On the basis of the interaction of the seawater with the tubes 21 containing the hot fluid, it happens that the tubes 21 and the fluid are cooled, and that the seawater heats up. On the basis of the latter effect, and possibly also motion of the ship, a natural flow of seawater is obtained in the wet compartment 10, wherein cold seawater enters the wet compartment 10 through the inlet openings 11, and wherein seawater at a higher temperature exits the wet compartment 10 through the outlet openings 12. Advantageously, the tubes 21 are made of a material having good heat transferring capabilities, such as copper. For the sake of clarity, it is noted that in FIG. 1, for illustration purposes, another orientation of the wet compartment 10 and the box cooler 20 associated with the wet compartment 10 is shown than the orientation which is known from practice, and which involves an upright position of the U shaped tubes 21 of the box cooler 20. In any case, the invention is in no way restricted to a particular orientation of components.

Top sides of the leg portions 21b of the tubes 21 are at a similar level in view of the fact that the top sides of the leg portions 21b of the tubes 21 are connected to a common tube plate 22. The tube plate 22 is covered by a fluid header 23 comprising at least one inlet stub 24 and at least one outlet stub 25 for the entry and the exit of fluid to and from the tubes 21, respectively. Hence, the leg portions 21b of the tubes 21 which are at the side of the inlet stub 24 are at the highest temperature, while the leg portions 21b of the tubes 21 which are at the side of the outlet stub 25 are at a lower temperature, and the same is applicable to the fluid flowing through the tubes 21.

During the continuous cooling process of the tubes 21 and the fluid as present in the tubes 21, any microorganisms being present in the seawater tend to attach to the tubes 21, especially the portions of the tubes 21 which are at an ideal temperature for providing a suitable environment for the microorganisms to live in, the phenomenon being known as biofouling. In order to prevent this phenomenon, it is proposed to use at least one lamp 30 for casting anti-fouling light on an exterior surface 26 of the tubes 21. For example, the light may be UVC light, which is known to be effective for realizing anti-fouling. In the shown example, a number of lamps 30 are used, each of the lamps 30 being arranged in the wet compartment 10, in the same area as the tubes 21, which does not alter the fact that numerous other possibilities exist as well in respect of the positioning of the lamps 30. Besides the use of the lamps 30, other measures may be taken for avoiding biofouling of the exterior surface 26 of the tubes 21. FIG. 1 illustrates an optional additional use of a so-called ICAF system 40 for producing copper ions.

The operation of the lamps 30 is controlled by means of a controller 50. The controller 50 is configured so as to realize operation of the lamps 30 in an optimal manner, namely by determining at least one operation parameter on the basis of a process in which at least one aspect of an actual condition of the wet compartment 10 is taken into account, especially at least one aspect related to the water as may be present in the compartment 10 and/or to the surface 26 to be kept free from biofouling and/or to the opening status of the inlet openings 11. FIG. 1 illustrates the fact that one or more sensors may be used for detecting an actual value of a parameter to be used in the process of determining how to control the lamps 30. In the shown example, one sensor 51 is provided for detecting a water-related parameter, whereas another sensor 52 is provided for detecting a surface-related parameter. Dashed lines extending between the controller 50 and the sensors 51, 52, between the controller 50 and the ICAF system 40, between the controller 50 and the lamps 30, and between the controller 50 and the inlet openings 11, respectively, represent the connections as present between the controller 50 and the various components as mentioned, which enable communication between the controller 50 and the components, so that an intelligent system 1 is obtained in which anti-fouling effects can be achieved at a minimum load of the lamps 30, which promotes a prolonged lifetime of the lamps 30, to mention one advantage. The controller 50 may be configured to operate all lamps 30 in a similar manner, but it is also possible that lamps 30 are controlled individually, which may be advantageous in situations in which it is desirable to have sophisticated control aimed at optimization at a level of various positions in the wet compartment 10.

The controller 50 may comprise a memory 60 for storing a fouling control model, so that appropriate values of at least one operation parameter of the lamps 30 can be determined on the basis of any possible input. In particular, such a fouling control model may be designed on the basis of knowledge about relations between various input parameters and output parameters which are optimal as far as anti-fouling effectiveness on the one hand and prevention of unnecessary high load of the lamps 30 on the other hand is concerned.

FIG. 2 illustrates the possible use of various sensors 51, 52, 53, 59 in the process of determining the at least one operation parameter of the lamps 30. Furthermore, FIG. 2 illustrates the fact that the one or more actual values as detected by the sensors 51, 52, 53, 59 may be supplied as input to a fouling control model 61 as mentioned in the foregoing. The fouling control model 61 describes a relation between biofouling and at least one of at least one water-related parameter, at least one surface-related parameter and at least one opening-related parameter, and the necessary lamp output to counteract the biofouling. Thus, based on the input provided by the sensors 51, 52, 53, 59, the fouling control model 61 defines optimum drive conditions of the lamps 30 and provides the at least one operation parameter associated with those optimum drive conditions to control electronics 31 of the lamps 30.

The extent to which water causes biofouling of a surface 26 depends on several physic-chemical and biological parameters. Examples are Total Organic Carbon (TOC), temperature, light, dissolved oxygen, pH, nutrients, dissolved organic matters, dissolved inorganic matters, suspended matter and shear forces. If the biofouling is caused by algal blooms, another parameter which can be used as an alternative indication of the biofouling potential of water is the algal content of the water. If algal concentrations exceed a certain value, the amount of algae is large enough to release organics triggering biofouling. Another similar indicator is the content of algae measured as chlorophyll-a. Water with a high amount chlorophyll-a can be expected to have very high biofouling propensity.

Besides the fouling control model 61, a lamp lifetime model 62 describing a relation between load of the lamps 30 and lifetime of the lamps 30 may also be used in the anti-fouling system 1. Assuming that the control electronics 31 are combined with electronics for monitoring load and behavior of the lamps 30, input for defining the expected lifetime of the lamps 30 can be obtained. All in all, based on the output of the sensors 51, 52, 53, 59 and the information regarding the behavior of the lamps 30, it is possible to determine the optimal lamp load (in terms of power, duty cycle, etc.) needed to counteract biofouling at a maximum lifetime of the lamps 30, by using the fouling control model 61 and the lamp lifetime model 62. Monitoring the lamp load and behavior also provides an indication of the expected end-of-life of the lamps 30.

In the anti-fouling system 1 as described in the foregoing and illustrated in the figures, any water-related parameter and/or surface-related parameter and/or opening-related parameter may be used in a process of finding a way of driving the lamps 30 for achieving the anti-fouling effect as desired at minimum load. An example of a surface-related parameter is the temperature of the surface 26. An example of an opening-related parameter is a state of the inlet openings 11, assuming that this state may vary between opened and closed, to which end suitable means such as valves may be used.

According to one possibility, the controller 50 is configured to active the ICAF system 40 only in situations in which the lamps 30 are known to be less effective, probably not effective enough for totally avoiding biofouling. An example of such situations is a situation in which the water has a low transparency to the ultraviolet light. According to another possibility, the controller 50 is configured so as to alternate the application of the lamps 30 and the ICAF system 40, in order to increase the lifetime of both the lamps 30 and the ICAF system 40 and to reduce the need for maintenance.

The controller 50 may furthermore be configured to take special action when the inlet openings 11 are put from an opened state to a closed state for a period of time. This may occur when the ship is in a harbor, for example. The special action may involve driving the lamps 30 at relatively high power during a time which is long enough for achieving a sterilizing effect on any water as may be present in the wet compartment 10. After that time, the lamps 30 may basically be kept in an inactive condition as long as the inlet openings 11 are kept in the closed state. There is also no need for driving the ICAF system 40 during that time. In fact, this way of doing is applicable to every situation in which there is no need to operate the box cooler 20, which is generally a situation in which the ship's engine is off.

Numerous other possibilities than the ones explicitly explained above exist within the concept of controlling operation of the lamps 30 in dependency of one or more parameters representing an actual condition of the wet compartment 10 and/or one or more components associated therewith. The exterior surface 26 of tubes 21 of a box cooler 20 is just one example of a surface as may be present in a wet compartment 10, which is to be kept free from biofouling. An interior surface 104 of the portion of the ship's hull 101 associated with the wet compartment 10 and/or the partition plates 102, 103 is another feasible example of such a surface. Furthermore, ultraviolet light is just one example of a type of light which is suitable to be used for anti-fouling purposes.

The invention is applicable to a ship as described in the foregoing, to any other type of vessel comprising a wet compartment 10, or to any other arrangement comprising a wet compartment 10, when there is a need for keeping a surface as present in the wet compartment 10 free from biofouling. The ship or other type of vessel, or the arrangement in a more general sense may comprise more than one wet compartment 10 to which the invention is applied, i.e. in which control of lamps 30 and/or other anti-fouling sources is based on feedback/information about one or more parameters relating to water as may be present in the wet compartment 10 and/or the surface 26, 104 to be kept clean and/or the state of the inlet openings 11.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof While the invention has been illustrated and described in detail in the figures and the description, such illustration and description are to be considered illustrative or exemplary only, and not restrictive. The invention is not limited to the disclosed embodiments. The drawings are schematic, wherein details that are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The term “comprise” as used in this text will be understood by a person skilled in the art as covering the term “consist of”. Hence, the term “comprise” may in respect of an embodiment mean “consist of”, but may in another embodiment mean “contain/include at least the defined species and optionally one or more other species”. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The term “substantially” as used in this text will be understood by a person skilled in the art as being applicable to situations in which a certain effect is intended which can be fully realized in theory but which involves practical margins for its factual implementation. Examples of such an effect include a parallel arrangement of objects and a perpendicular arrangement of objects. Where applicable, the term “substantially” may be understood such as to be an adjective which is indicative of a percentage of 90% or higher, such as 95% or higher, especially 99% or higher, even more especially 99.5% or higher, including 100%.

In view of the fact that biofouling does not only occur at sea, but also in rivers, lakes and the like, the invention is generally applicable in a context in which a wet compartment 10 is present, which may be filled with any kind of water. This context may be the context of a vessel, as mentioned earlier, or even more general, the context of marine objects such as oilrigs, or other types of buildings in or next to the ocean, which does not alter the fact that the invention may also be applicable in the context of a domestic appliance in which water is used during operation thereof, for example, such as a coffee maker or a water disinfector, or another context which may be totally different from the context of marine objects.

In respect of the possible application of the invention in the context of a wet compartment 10 accommodating a box cooler 20, it is noted that the invention is in no way restricted to the layout of the box cooler 20 as described in the foregoing and illustrated in FIG. 1 as an example. It is clear to a person skilled in the art that the features of the invention are not dependent on any feature of the surface 26, 104 to be protected against the fouling effect of water. Also, the application of ultraviolet lamps 30 for realizing anti-fouling effects during operation thereof is just one of the many possibilities existing within the framework of the invention. In the embodiments of the invention as shown, the wet compartment 10 is used for accommodating the tubes 21 of a box cooler 20, which tubes 21 are to be considered as just one example of a functional unit. Additionally or alternatively, the wet compartment 10 may be used for accommodating one or more other objects/units, but may also be empty, i.e. does not need to contain any objects/units. For example, in case the anti-fouling system is applied in a ship, the wet compartment 10 may be a so-called sea chest for taking in ballast water or fire extinguishing water.

In the shown embodiment of the wet compartment 10, a number of inlet openings 11 for allowing water to enter the wet compartment 10 and a number of outlet openings 12 for allowing water to exit the wet compartment 10 are present. That does not alter the fact that the option of only a single opening being present, wherein the opening has a combined function of being an inlet opening and an outlet opening, is also covered by the invention. For the sake of completeness, it is noted that it is not essential to have at least one outlet opening 12, on the basis of the fact that practical cases exist in which there is no need for emptying the wet compartment 10 through one or more outlet openings 12 after initial filling of the wet compartment 10.

In the context of the invention, the term “compartment” should preferably be understood such as to mean something like a separate room, basin, section, or chamber. The adjective “wet” is used to indicate that the compartment 10 is intended to be at least partially filled with water, which does not alter the fact that the compartment 10 may be in a dry condition under appropriate circumstances.

Summarizing, an anti-fouling system 1, designed to be used with a wet compartment 10 having at least one inlet opening 11 for allowing water to enter the wet compartment 10 is configured to receive and operate at least one anti-fouling source 30 for emitting anti-fouling light in order to keep at least one surface 26, 104 as present in the wet compartment 10 free from biofouling. For example, the at least one anti-fouling source 30 for use in the anti-fouling system 1 may be adapted to irradiate the surface 26, 104 with ultraviolet light. The anti-fouling system 1 comprises a controller 50 for controlling operation of the at least one anti-fouling source 30 when the anti-fouling source 30 is received in the anti-fouling system 1 and the anti-fouling system 1 is used with the wet compartment 10, the controller 50 being configured to determine at least one operation parameter of the at least one anti-fouling source in relation to at least one of at least one water-related parameter, at least one surface-related parameter and at least one opening-related parameter so as to take into account as least one aspect of an actual situation prevailing in the wet compartment 10 in a process of setting the at least one operation parameter. On the basis of the special configuration of the controller 50, it is possible to avoid unnecessary high load of the at least one anti-fouling source 30 in the process of preventing biofouling, which is beneficial to the lifetime of the anti-fouling source 30.

1. An anti-fouling system, designed to be used with a wet compartment having at least one inlet opening for allowing water to enter the wet compartment, the anti-fouling system being configured to receive and operate at least one anti-fouling source for emitting anti-fouling light in order to keep at least one surface as present in the wet compartment free from biofouling, and the anti-fouling system comprising a controller for controlling operation of the at least one anti-fouling source when the anti-fouling source is received in the anti-fouling system and the anti-fouling system is used with the wet compartment, the controller being configured to determine at least one operation parameter of the at least one anti-fouling source in relation to at least one of:
at least one surface-related parameter;
at least one opening-related parameter;
a rate of a flow of water along the surface to be kept free from biofouling;
a temperature of water inside the wet compartment;
an algal content of water inside the wet compartment;
a concentration of copper ions in water inside the wet compartment;
a concentration of chlorine in water inside the wet compartment;
a temperature of the surface to be kept free from biofouling; and
a rate of a flow of water through the at least one inlet opening of the wet compartment, and the anti-fouling system also comprising at least one sensor for detecting an actual value of the at least one parameter, the sensor being associated with the controller so as to be capable of providing feedback about the value to the controller.

2. (canceled)

3. (canceled)

4. The system according to claim 1, particularly designed to be used with a wet compartment of which the at least one inlet opening is adapted to be in one of an opened state and a closed state, wherein the controller is configured to control the at least one anti-fouling source for providing a dose of anti-fouling light followed by switching off the anti-fouling source or only operating the anti-fouling source to a minimal extent when the opening is put from the opened state to the closed state, and to keep the anti-fouling source in a state of no or minimal activity, at least during a predetermined period of time as long as the closed state is maintained.

5. (canceled)

6. The system according to claim 1, wherein the controller is configured to determine an intensity of anti-fouling light to be emitted by the at least one anti-fouling source through time in relation to the at least parameter.

7. The system according to claim 1, wherein the controller comprises a memory in which a fouling control model configured to determine output related to the at least one operation parameter of the at least one anti-fouling source in relation to input related to the at least one parameter is stored.

8. The system according to claim 1, designed for receiving and operating at least one anti-fouling source for emitting ultraviolet light.

9. The system according to claim 1, wherein the surface to be kept free from biofouling includes an interior surface of an actual structure of the wet compartment.

10. The system according to claim 1, particularly designed to be used with a wet compartment in which a functional unit is arranged, wherein the surface in the wet compartment to be kept free from biofouling includes an exterior surface of the functional unit.

11. A vessel comprising a wet compartment having at least one inlet opening for allowing water to enter the wet compartment and the anti-fouling system according to claim 1.

12. A vessel comprising a wet compartment having at least one inlet opening for allowing water to enter the wet compartment and the anti-fouling system according to claim 1, and further comprising machinery, a functional unit of the machinery being arranged in the wet compartment, wherein the surface in the wet compartment to be kept free from biofouling includes at least one of an interior surface of the actual structure of the wet compartment and an exterior surface of the functional unit of the machinery.

13. A method for controlling operation of at least one anti-fouling source of an anti-fouling system when the anti-fouling system is used with a wet compartment having at least one inlet opening for allowing water to enter the wet compartment, the at least one anti-fouling source being configured to emit anti-fouling light in order to keep at least one surface as present in the wet compartment free from biofouling, and the method involving a step of determining at least one parameter of the operation of the at least one anti-fouling source in relation to at least one of:
at least one surface-related parameter;
at least one opening-related parameter;
a rate of a flow of water along the surface to be kept free from biofouling;
a temperature of water inside the wet compartment;
an algal content of water inside the wet compartment;
a concentration of copper ions in water inside the wet compartment;
a concentration of chlorine in water inside the wet compartment;
a temperature of the surface to be kept free from biofouling; and
a rate of a flow of water through the at least one inlet opening of the wet compartment, and a step of detecting an actual value of the at least one parameter.

14. The method according to claim 13, wherein the anti-fouling system is particularly used with a wet compartment of which the at least one inlet opening is adapted to be in one of an opened state and a closed state, wherein the at least one anti-fouling source is controlled for providing a dose of anti-fouling light followed by switching off the anti-fouling source or only operating the anti-fouling source to a minimal extent when the opening is put from the opened state to the closed state, and wherein the anti-fouling source is kept in a state of no or minimal activity, at least during a predetermined period of time as long as the closed state is maintained.

15. A controller for controlling operation of at least one anti-fouling source of an anti-fouling system when the anti-fouling system is used with a wet compartment having at least one inlet opening for allowing water to enter the wet compartment, the at least one anti-fouling source being configured to emit anti-fouling light in order to keep at least one surface as present in the wet compartment free from biofouling, and the controller being configured to determine at least one operation parameter of the at least one anti-fouling source in relation to at least one of:
at least one surface-related parameter;
at least one opening-related parameter;
a rate of a flow of water along the surface to be kept free from biofouling;
a temperature of water inside the wet compartment;
an algal content of water inside the wet compartment;
a concentration of copper ions in water inside the wet compartment;
a concentration of chlorine in water inside the wet compartment;
a temperature of the surface to be kept free from biofouling; and
a rate of a flow of water through the at least one inlet opening of the wet compartment.
